(19) United States
(12) Patent Application Publication
(10) Pub. No.: US 2024/0161449 A1
(43) Pub. Date: May 16, 2024

(54) APPARATUS AND METHODS FOR CONVERTING LINELESS TALBES INTO LINED TABLES USING GENERATIVE ADVERSARIAL NETWORKS

(71) Applicant: EYGS LLP, London (GB)

(72) Inventors: Mehrdad Jabbarzadeh GANGEH, Mountain View, CA (US); Hamid Reza MOTAHARI NEZAD, Los Altos, CA (US)

(21) Appl. No.: 18/419,946

(22) Filed: Jan. 23, 2024

Related U.S. Application Data
(63) Continuation of application No. 16/546,938, filed on Aug. 21, 2019, now Pat. No. 11,915,465.

(51) Int. Cl. G06V 10/44; G06F 16/25; G06N 3/045; G06N 3/088; G06V 10/82; G06V 30/19; G06V 30/412; G06V 30/414

(52) U.S. Cl. CPC G06V 10/454; G06F 16/258; G06N 3/045; G06N 3/088; G06V 10/82; G06V 30/19173; G06V 30/412; G06V 30/414

(57) ABSTRACT

A method for converting a lineless table into a lined table includes associating a first set of tables with a second set of tables to form a set of multiple table pairs that includes tables with lines and tables without lines. A conditional generative adversarial network (cGAN) is trained, using the table pairs, to produce a trained cGAN. Using the trained cGAN, lines are identified for overlaying onto a lineless table. The lines are overlaid onto the lineless table to produce a lined table.

### CROSS-REFERENCE TO RELATED APPLICATIONS

This application is a continuation of U.S. patent application Ser. No. 16/546,938, titled “Apparatus and Methods for Converting Lineless Tables into Tables Using Generative Adversarial Networks” and filed Aug. 21, 2019, the entire disclosure of which is hereby incorporated by reference.

### TECHNICAL FIELD

The present disclosure generally relates to the detection of a table structure within an electronic file, and in particular, the conversion of a lineless table into a lined table.

### BACKGROUND

Tables are compact, efficient tools for summarizing relational information and are used in a wide variety of documents such as forms, invoices, scientific papers, newspaper articles, etc. Although the human eye can readily perceive a table within a text document, the automated/computer-based detection and understanding of tables remains challenging to implement.

### SUMMARY

In some embodiments, a method for converting a lineless table into a lined table includes associating a first set of tables with a second set of tables to form a plurality of table pairs that includes tables with lines and tables without lines. A conditional generative adversarial network (cGAN) is trained, using the plurality of table pairs, to produce a trained cGAN. Using the trained cGAN, a plurality of lines are identified for overlaying onto a lineless table. The plurality of lines are overlaid onto the lineless table to produce a lined table.

In some embodiments, a method for converting a lineless table into a lined table includes generating training data via a processor. The training data includes a first dataset with at least one of lineless formatted data or partially lined formatted data, and a second dataset with formatted data with format lines, the second dataset being associated with the first dataset. An artificial neural network (ANN) is trained using the training data based on at least one of a local visual structure or a global visual structure of the training data, to produce a trained ANN configured to predict line placement for at least one of a lineless table or a partially lined table.

In some embodiments, a system for converting a lineless table into a lined table includes a processor and a memory storing instructions executable by the processor. The instructions include instructions to receive a first table that is one of a lineless table or a partially lined table. The instructions also include instructions to generate a second table that is a lined table based on the first table and using a trained neural network model that predicts line placement based on structural attributes of the first table.

### BRIEF DESCRIPTION OF THE DRAWINGS

FIGS. 1A-1D are diagrams illustrating a method of detecting table structure for a lineless table, according to some embodiments.

FIG. 2 is a flowchart illustrating an example method for converting a lineless table into a lined table, according to some embodiments.

FIG. 3 is a flowchart illustrating an example method for training a machine learning model to convert a lineless table into a lined table, according to some embodiments.

FIG. 4 is a flowchart illustrating an example system for converting a lineless table into a lined table, according to some embodiments, according to some embodiments.

FIGS. 5A-5C are diagrams showing an inverted graphical representation of text regions of a lined and lineless table, according to some embodiments.

FIG. 6 is a flowchart illustrating an example method for training a Conditional Generative Adversarial Network (cGAN) and using the trained cGAN to convert a lineless table into a lined table, according to some embodiments.

FIG. 7 is a flowchart illustrating an example method for removing lines from a table, according to some embodiments.

FIG. 8 is a diagram showing an architecture of a cGAN-based training system, according to some embodiments.

FIGS. 9A-9C are diagrams showing a first example set of results from converting a lineless table into a lined table, according to some embodiments.

FIGS. 10A-10C are diagrams showing a second example set of results from converting a lineless table into a lined table, according to some embodiments.

### DETAILED DESCRIPTION

Documents such as leases, invoices, and schedules (e.g., Schedule K-1) often include tables that do not have horizontal and/or vertical lines. Without these lines to separate the table cells, known algorithms for extracting information from tables, which typically rely on the presence of semantic tags or other formatting cues, can fail to accurately extract the information. Known multiresolution techniques/algorithms can also include several feature-engineered steps that are performed sequentially, and as such, can suffer from inefficiencies cause by error propagation between the sequential steps. For example, (1) one or more known multiresolution approaches (such as wavelets) can be used to estimate an overall structure of a lineless or partially lined table, and (2) lines can subsequently be generated based on the estimated structure of the table. Such approaches, however involve multiple steps and are prone to error propagation between the steps. Moreover, no known methods exist for predicting the placement of lines in lineless or partially lined tables based on their visual structure.

Methods of the present disclosure address the foregoing issues by performing multiple tasks (such as steps (1) and (2) described above) in a single step (e.g., a training step), in an end-to-end manner, such that error propagation between multiple steps is reduced or eliminated. As used herein, “end-to-end” describes a process that directly maps an input data (e.g., a table without lines or with partial lines) to an output prediction (e.g., the predicted lines in the input table), bypassing the intermediate step(s) typically used in a traditional approach. Some embodiments set forth herein can predict horizontal and/or vertical lines for a table lacking such lines, based on the overall visual structure of the table and using artificial intelligence (AI) methods such as artificial neural network-based deep learning. The table cells can then be identified, resulting in faster, more efficient and more accurate extraction of data from the table (particularly when applied to automated data extraction), as compared with known automated data extraction approaches. Data extraction techniques compatible with the resulting, lined table can include optical character resolution (OCR), Huffman Transforms, graphical-based methods, etc.

In some embodiments, entries are detected in a table that does not have lines (e.g., boundary lines, elongate graphical features, contour lines, lines between adjacent rows, and/or lines between adjacent columns). Training data is generated by obtaining sample tables and forming one version with lines and one version without lines. The training data is then used to train a conditional generative adversarial network (cGAN). In use, when a table without lines is to be processed, the trained cGAN produces a version of the table with the lines added, making subsequent text extraction more effective.

In some embodiments, an algorithm based on one or more multiscale deep generative adversarial networks/models is used to predict line placement for a lineless table based on its visual structure. The predicted lines are superimposed on the lineless table to produce a lined table. The algorithm can be executed in both a “global scale” (i.e., using global structural features of the table) and a “local scale” (i.e., using local structural features of the table) when identifying or predicting lines for separating rows and/or columns, resulting in highly accurate line prediction. Global structures of a table and local structures of a table can be taken into consideration, for example, using kernels of varying size in a convolutional network (which can be part of one or more generative and/or adversarial networks in the cGAN). According to some embodiments set forth herein, atrous convolution is used for multiresolution analysis and estimation of both global and local structures in a table. Use of the algorithm is preceded by a training phase, for example where the algorithm includes a cGAN. The cGAN is trained, for example, to accomplish supervised image-to-image translation, in which pairs of tables are generated based on an initial, lined table. Lines of the lined table are detected and removed, for example using morphological operators, to produce a corresponding lineless table. In other embodiments, a GAN is trained in an unsupervised manner, with the training input being an image, and using both lined and lineless tables that are not paired. In some embodiments, the prediction of line placement for lineless tables is performed according to a method that is not “rule based.”

As used herein, a “lineless table” refers to tabular data (i.e., text-based data/information that is arranged in rows and columns or any other organized arrangement) that either does not include any lines or other graphical features (e.g., dividers, symbols, differences in font, etc.) that serve as a “guide to the eye” and to demarcate boundaries between rows, columns, or other sub-section of the arranged data. A “lineless table” can also refer to tabular data that includes only a partial set of one or more such lines or other graphical features (e.g., tabular data that: is surrounded by an outer box/border but otherwise includes no lines, or includes lines separating columns but no lines separating rows, or includes an outer box/border and lines separating columns but no lines separating rows, or includes lines separating rows but no lines separating columns, or includes an outer box/border and lines separating rows but no lines separating columns, or includes lines separating only a subset of the columns and/or includes lines separating only a subset of the rows, or includes an outer box/border and lines separating only a subset of the columns and/or includes an outer box/border and lines separating only a subset of the rows). Table data can include words, letters, numbers, special characters, equations, etc.

Images that can include lineless tables and that are suitable for processing by systems and methods set forth herein can include one or more of the following, by way of example only: digital graphics files such as raster images (i.e., pixel-based images), vector graphics (i.e., graphics based on mathematical formulas defining geometric polygons such as polygons, lines, curves, circles and rectangles), raster graphics, bitmap images, bitmaps, dot matrix data structures, etc.

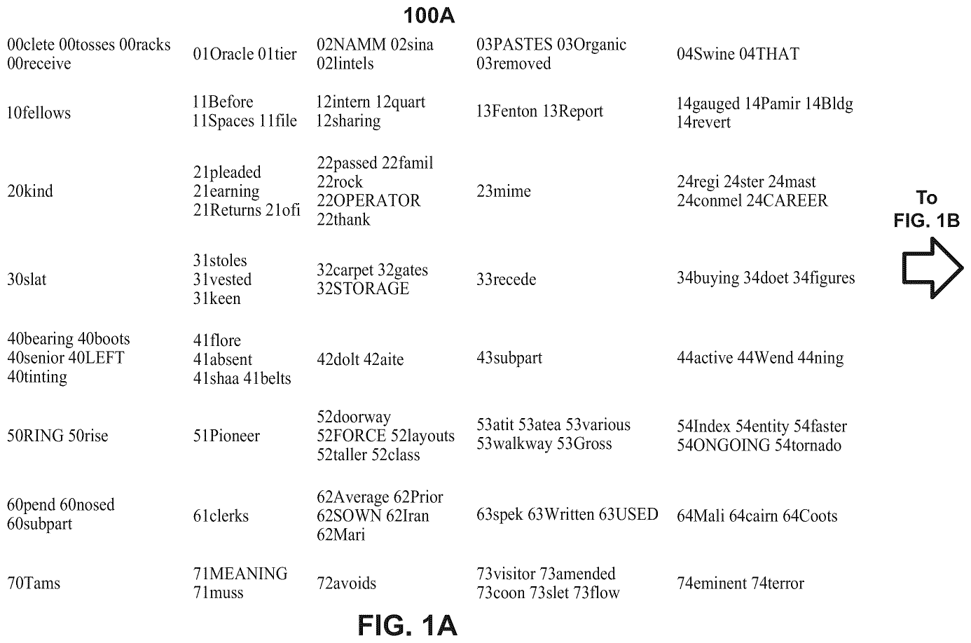

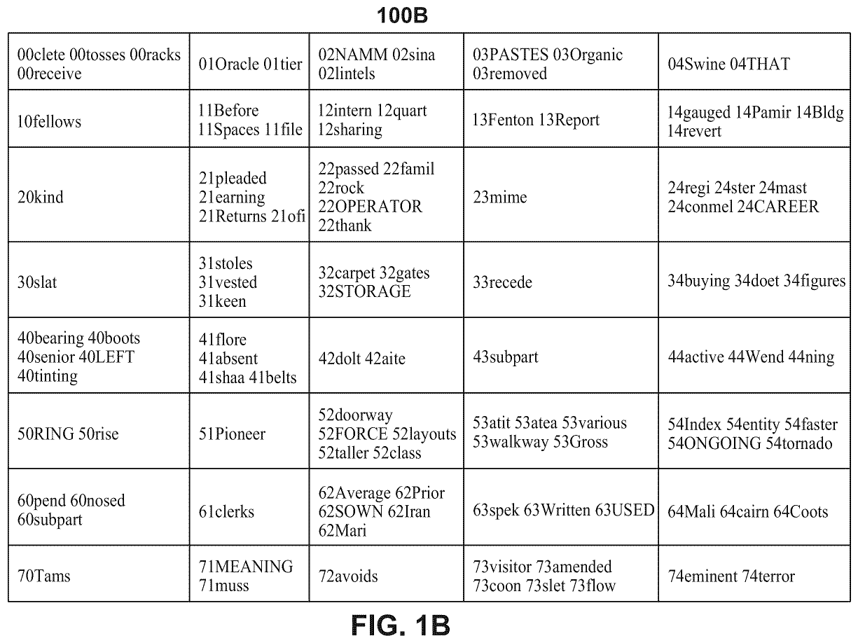

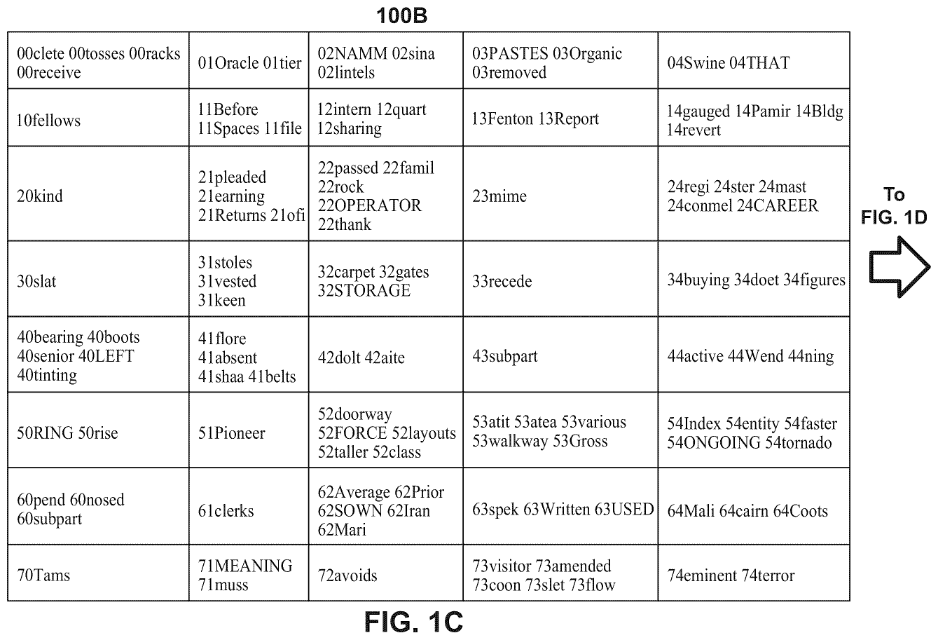

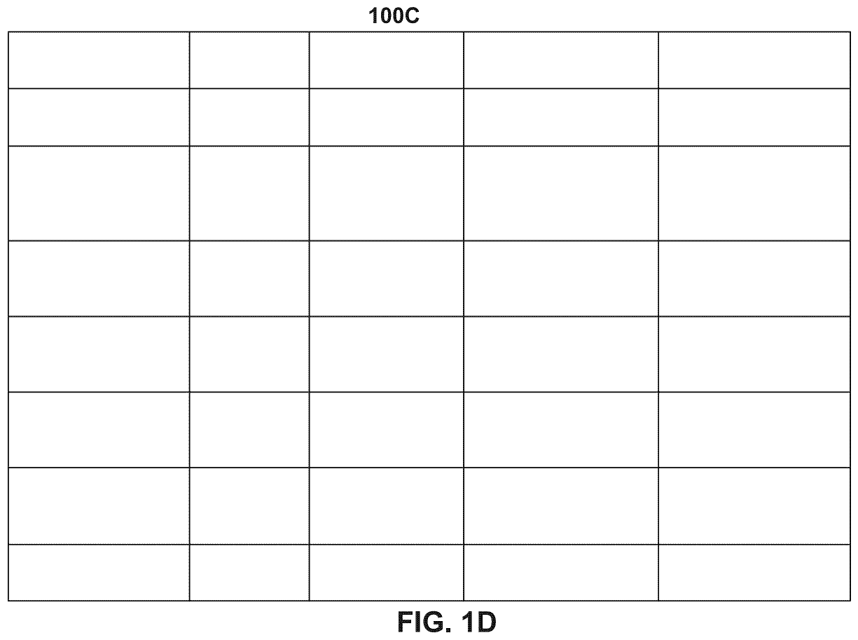

FIGS. 1A-1D are diagrams illustrating a method of detecting table structure for a lineless table, according to some embodiments. As shown in FIGS. 1A-1D, the lineless table 100A includes data arranged in rows and columns. Although the human eye can easily see macroscale and microscale patterns within such data, machines (i.e., compute devices) typically analyze data at too small a scale to detect those patterns. According to systems and methods set forth herein, given a table without horizontal and vertical lines (100A), or a table with partial horizontal and vertical lines, a generative adversarial network (which is a deep neural network architecture) can be developed and trained to predict all lines in the table based on the visual structure of the table. The table at 100B shows an example of predicted lines demarcating rows and columns, generated based on the data in table 100A and using the deep generative adversarial network. The lines can be isolated (at 100C) by removing the data appearing in the original lineless table 100A.

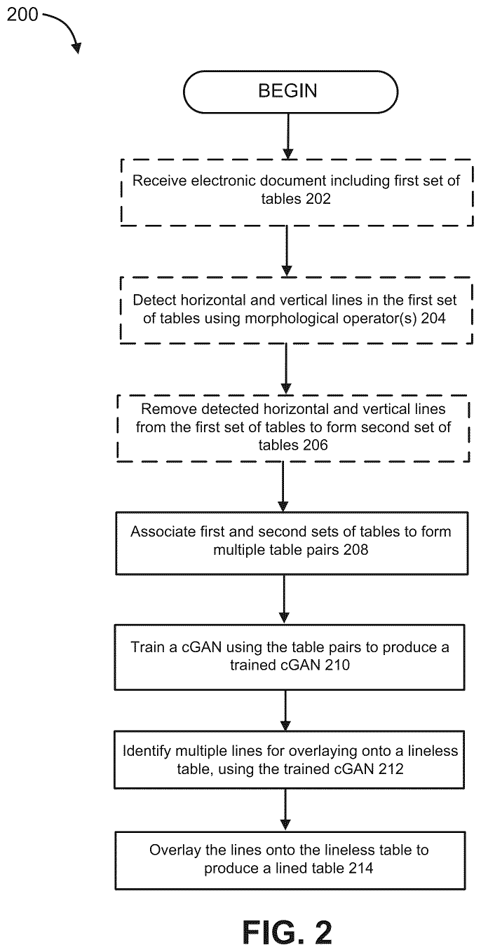

FIG. 2 is a flowchart illustrating an example method for converting a lineless table into a lined table, according to some embodiments. As shown in FIG. 2, the method 200 optionally includes receiving, at 202 and via a processor, at least one electronic document including a first set of tables (e.g., including one or more tables in the form of image data). At 204, horizontal lines and vertical lines are detected in the first set of tables using at least one morphological operator, such as dilation and/or erosion. The detected horizontal lines and the detected vertical lines are removed from the first set of tables, at 206, to generate a second set of tables. The first set of tables is associated with the second set of tables at 208 to form multiple table pairs that include tables with lines and tables without lines. A conditional generative adversarial network (cGAN) is trained, at 210, using the plurality of table pairs, to produce a trained Cgan. The cGAN provides a framework for a supervised image-to-image translation. The cGAN includes a generative algorithm and a discriminative algorithm, and the discriminative algorithm is configured to authenticate, during the training phase/step, table pairs from the plurality of table pairs (i.e., a “ground truth”) based on a predicted (lined) table produced by the generative algorithm. Multiple lines are identified at 212, using the trained cGAN, for overlaying onto a lineless table. The multiple lines are overlaid onto the lineless table at 214 to produce a lined table.

In some embodiments, the first set of tables includes one or more tables in the form of image data, and the method 200 of FIG. 2 also includes converting the table images into a binary (e.g., black-and-white) image based on an adaptive threshold method (e.g., Otsu's adaptive threshold method). In other embodiments, the cGAN includes a discriminative algorithm, and a modified version of the method 200 of FIG. 2 can also include calculating a quality metric via the discriminative algorithm based on an initial table from the first set of tables. In still other embodiments, the cGAN includes a discriminative algorithm, and a modified version of the method 200 of FIG. 2 can also include calculating a quality metric via the discriminative algorithm based on an initial table from the first set of tables. The quality metric is then passed as an input to a generative algorithm of the cGAN during the training of the cGAN. In still other embodiments, the cGAN includes a generative algorithm and a discriminative algorithm. The discriminative algorithm is configured to authenticate table pairs from the plurality of table pairs based on a predicted table produced by the generative algorithm. Each of the generative algorithm and the discriminative algorithm can include at least one convolutional neural network layer.

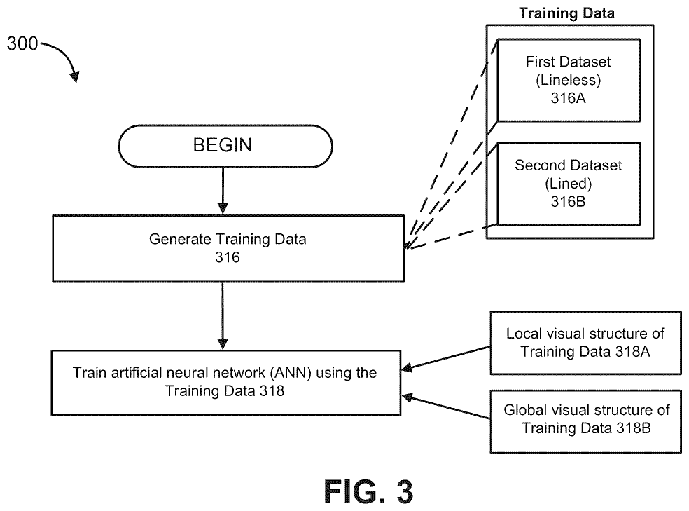

FIG. 3 is a flowchart illustrating an example method for training a machine learning model to convert a lineless table into a lined table, according to some embodiments. As shown in FIG. 3, the method 300 includes generating training data, at 316 and via a processor. The training data includes a first dataset 316A including at least one lineless table, and a second dataset 316B including at least one lined table, the second dataset being associated with the first dataset. The first dataset 316A and the second dataset 316B collectively define training data. The method 300 also includes training an artificial neural network (ANN), at 318, based on a local visual structure 318A of the training data and a global visual structure 318B of the training data, to produce a trained ANN configured to predict line placement for a lineless table. The trained ANN can include a conditional generative adversarial network (cGAN), e.g., a supervised cGAN. Alternatively or in addition, the trained ANN can include at least one generative algorithm and at least one discriminative algorithm.

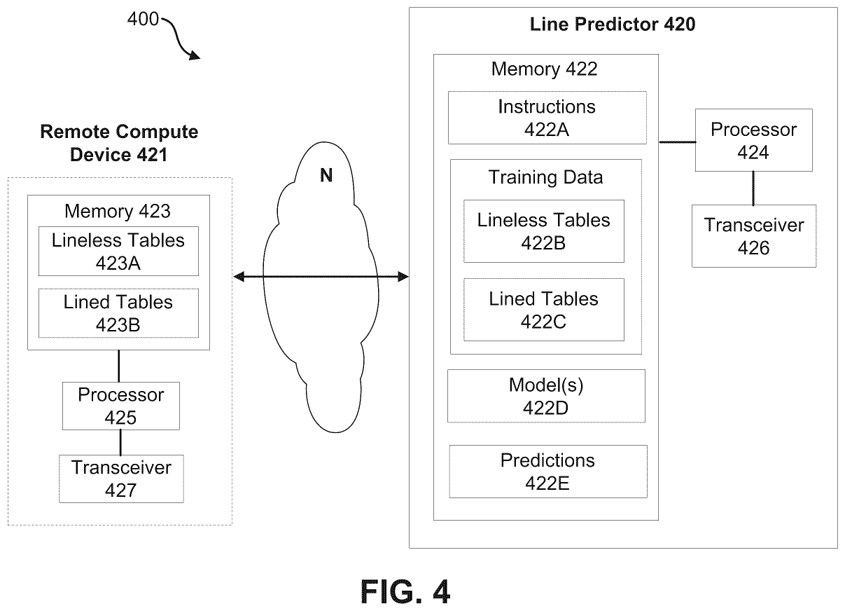

FIG. 4 is a flowchart illustrating an example system for converting a lineless table into a lined table, according to some embodiments, according to some embodiments. As shown in FIG. 4, the system 400 includes a line predictor 420. The line predictor 420 includes a processor 424, a transceiver 426 (i.e., a transmitter and a receiver) operably coupled to the processor 424, and a memory 422 operably coupled to the processor 424. The memory 422 stores instructions 422A, executable by the processor to receive a first, lineless table (which may be stored in the memory 422 at 422B), and generate a second table that is a lined table (which may be stored in the memory 422 at 422C) based on the first table and using a trained neural network model (which may be stored in the memory 422 at 422D) that predicts line placement based on structural attributes of the first table. The predictions can be stored in the memory 422 at 422E. The trained neural network model can be a cGAN (e.g., including at least one convolutional neural network layer). Generating the second table can include determining at least one predicted line and superimposing the predicted line onto an image of the first table. The instructions 422A can include instructions executable by the processor 424 to send a signal (e.g., via the transceiver 426 and over a wired or wireless communications network “N”) to cause display of the second table within a graphical user interface (GUI) of a user (e.g., of remote compute device 421 and/or of line predictor 420). The remote compute device 421 includes a memory 423, a processor 425 operably coupled to the memory 423, and a transceiver 427 operatively coupled to the processor 425. The memory 423 can store lineless tables 423A (which may also be sent to the line predictor 420, via the network N, for conversion into lined tables) and/or lined tables 423B (e.g., received from the line predictor 420 in response to sending a lineless table to the line predictor 420 for conversion into a lined table).

In some implementations, the trained neural network model stored at 422D is a cGAN that includes a multiresolution generative network and a multiresolution discriminative network. The structural attributes of the first table can include global visual structural attributes of the first table and local visual structural attributes of the first table. As used herein, a “local attribute” can refer, by way of example, to a short-range structural feature of the table (e.g., a relationship of a pixel to one or more other pixels in close proximity thereto (i.e., within the pixel's “neighborhood”)), and a “global attribute” can refer, by way of example, to a longer-range structural feature of the table (e.g., a relationship of a pixel to one or more other pixels relatively remote or far from that pixel (i.e., not within the pixel's neighborhood)).

In some implementations, the trained neural network model stored at 422D is a cGAN that includes at least one convolutional neural network layer that includes an atrous convolutional neural network layer. The structural attributes of the first table can include at least one of global visual structural attributes of the first table or local visual structural attributes of the first table.

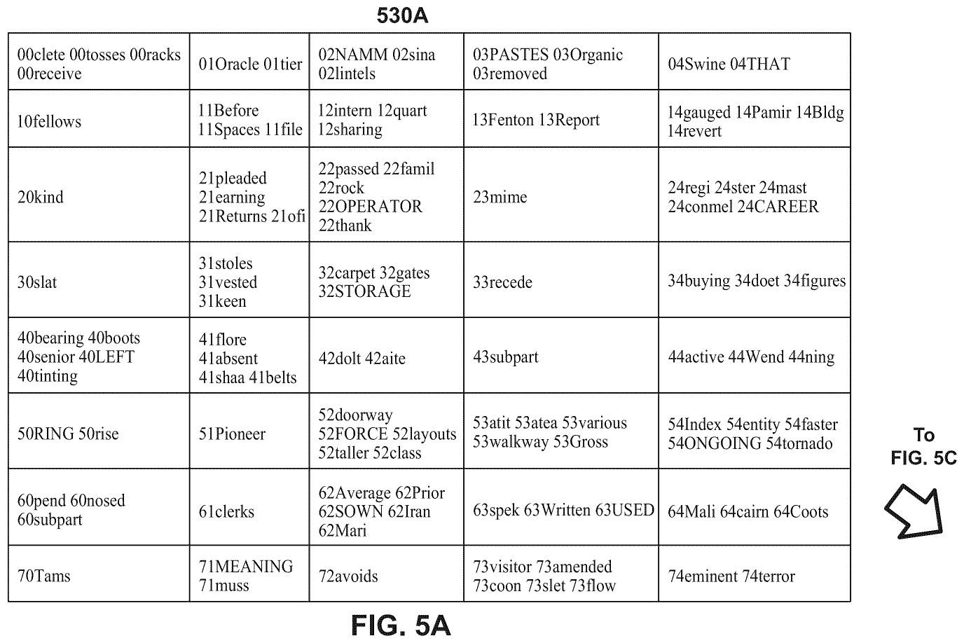

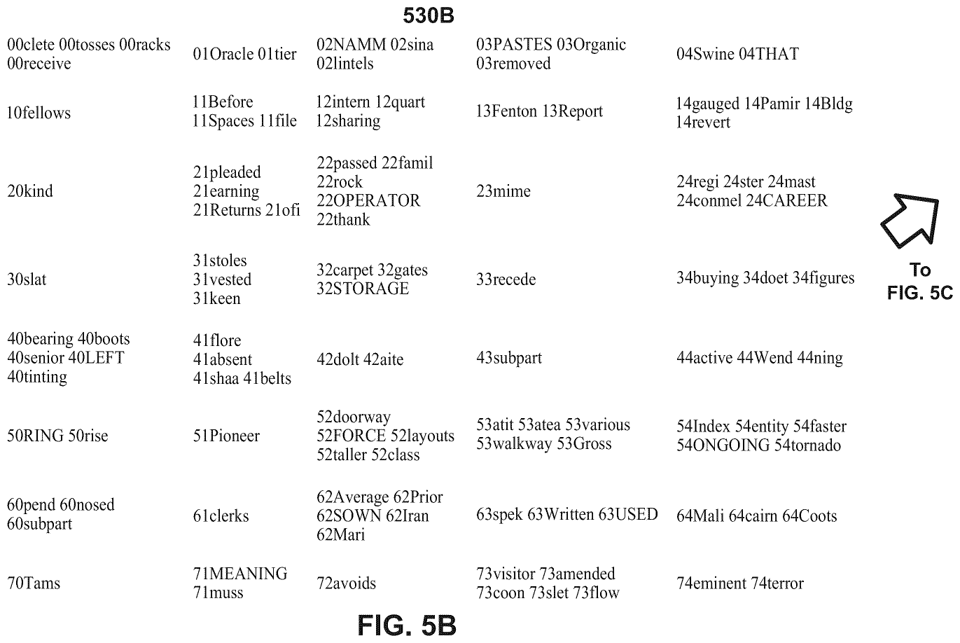

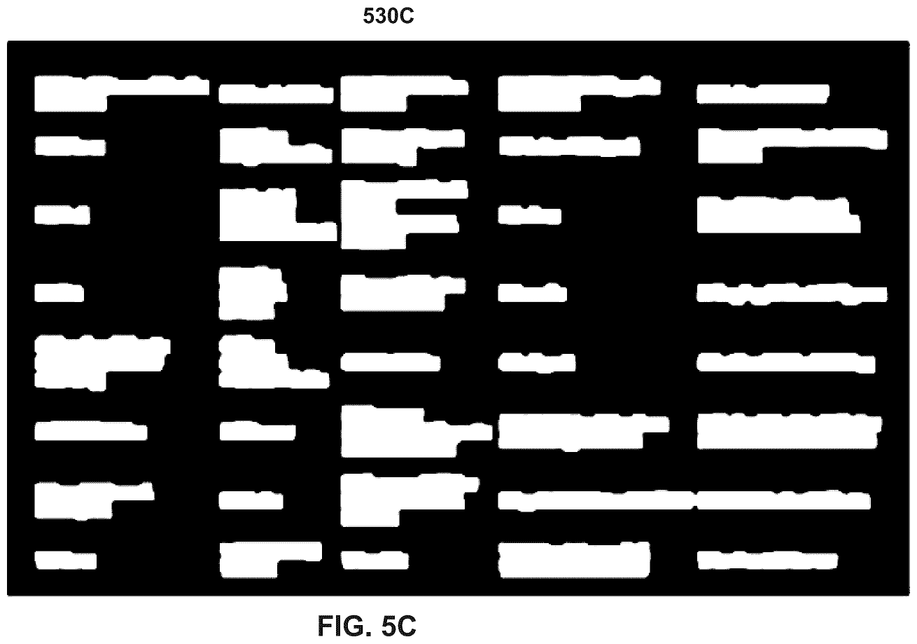

FIGS. 5A-5C are diagrams showing an inverted graphical representation of text regions of a lined and lineless table, according to some embodiments. Each of lined table 530A and lineless table 530B includes text within cells that can be readily distinguished/identified by the human eye. Each separate text region from the table is represented as a white region in graphic 530C. Without lines, known information extraction algorithms can fail to correctly identify table cells, particularly those with reduced separation between them (e.g., see the close texts in adjacent cells on rows 1, 2, 3, and columns 2, 3 of tables 530A and 530B). Methods set forth herein can generate predictions of the proper placement of vertical and horizontal lines in a table based on its overall visual structure, substantially improving the accuracy of row and column prediction for the table and thereby improving the performance of any subsequently-employed data extraction algorithm.

In some embodiments, an algorithm for predicting lines of a table based on a visual structure of the table includes a supervised image-to-image translation or an unsupervised image-to-image translation. Image-to-image translation can be used for one or more of: edge detection, semantic segmentation, conversion of images from black and white to color, day-to-night scene conversion (and vice versa), etc.

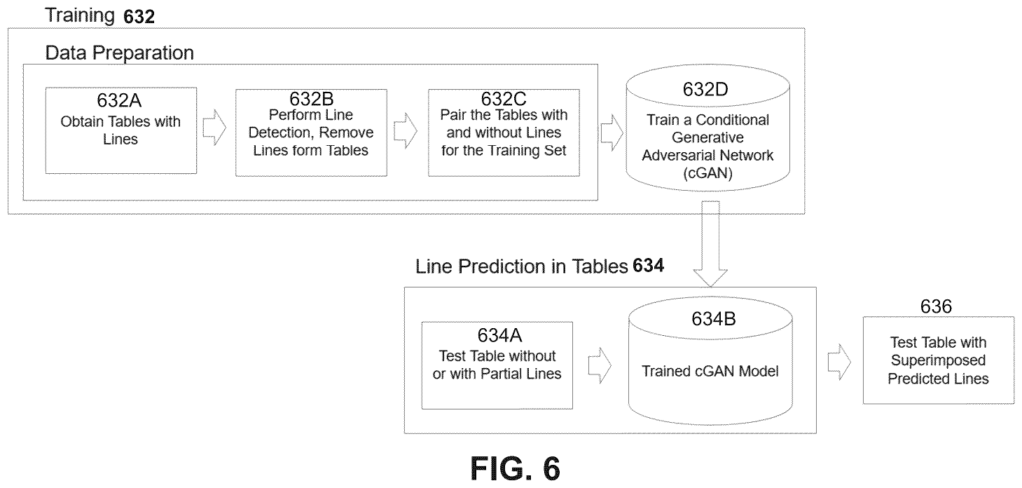

FIG. 6 is a flowchart illustrating an example method for training a Conditional Generative Adversarial Network (cGAN) and using the trained cGAN to convert a lineless table into a lined table, according to some embodiments. As shown in FIG. 6, a training sequence 632 includes obtaining tables with lines at 632A, performing line detection on the lined tables and removing lines from the tables based on the line detection (at 632B), and pairing the tables with lines with their counterpart/corresponding lineless tables, at 632C, to form a training data set. Steps 632A-632C represent a data preparation sequence. An example code snippet illustrating a procedure for removing lines from a table using morphological operators is as follows:

In [1]:
import glob
import os
import sys
from matplotlib import pyplot as plt
%matplotlib inline
import cv2
import numpy as np
In [2]:
def dilate(ary, N, iterations):
“““Dilate using an NxN ‘+’ sign shape. ary is np.uint8.”””
kernel = np.zeros((N,N), dtype=np.uint8)
kernel[(N−1)//2,:] = 1
dilated_image = cv2.dilate(ary / 255, kernel, iterations=iteration
s)
dilated_image = cv2.dilate(ary, kernel, iterations=iterations)

kernel = np.zeros((N,N), dtype=np.uint8)
kernel[:,(N−1)//2] = 1
dilated_image = cv2.dilate(dilated_image, kernel, iterations=iterations)
return dilated_image

def crop_table(im):

“““Calculate bounding box for each contour.”””
gray = cv2.cvtColor(im, cv2.COLOR_BGR2GRAY)
th, threshed = cv2.threshold(gray, 127, 255, cv2.THRESH_BINARY_INV

| cv2.THRESH_OTSU)
pts = cv2.findNonZero(threshed)
rect = cv2.minAreaRect(pts)
(cx, cy), (w, h), ang = rect
print(‘width: { } and height: { }’.format(w, h))
crop_im = im[:int(h + 200),:int(w + 200),:]
return crop_im
def remove_lines(img):
gray = cv2.cvtColor(img, cv2.COLOR_BGR2GRAY)
th, thresh1 = cv2.threshold(gray, 127, 255, cv2.THRESH_OTSU)
th, thresh = cv2.threshold(gray, 127, 255, cv2.THRESH_BINARY_INV |
cv2.THRESH_OTSU)
horizontal_img = thresh
vertical_img = thresh
kernel = cv2.getStructuringElement(cv2.MORPH_RECT, (100,1))
horizontal_img = cv2.erode(horizontal_img, kernel, iterations=1)
horizontal_img = cv2.dilate(horizontal_img, kernel, iterations=1)
kernel = cv2.getStructuringElement(cv2.MORPH_RECT, (1,100))
vertical_img = cv2.erode(vertical_img, kernel, iterations=1)
vertical_img = cv2.dilate(vertical_img, kernel, iterations=1)
mask_img = horizontal_img + vertical_img
no_line = np.bitwise_or(thresh1, mask_img)
return no_line
in [3]:
img_dir = “./tables/originalTest1” # Enter Directory of all images
data_path = os.path.join(img_dir, “*.jpg”)
files = glob.glob(data_path)
In [4]:
count = 0
for f1 in files:
count += 1
print(‘\n’)
print(‘file no.: { }, filename: { }’.format(count, f1))
im = cv2.imread(f1)
crop_im = crop_table(im)
image = remove_lines(crop_im)
IMAGE_SIZE = (24,16)
plt.figure(figsize = IMAGE_SIZE)
plt.imshow(im, cmap = ‘gray’)
plt.title(‘Original Image’)#, plt.xticks([ ]), plt.yticks([ ])
plt.show( )
plt.figure(figsize = IMAGE_SIZE)
plt.imshow(crop_im, cmap = ‘gray’)
plt.title(‘Cropped Image’)#, plt.xticks([ ]), plt.yticks([ ])
plt.show( )
plt.figure(figsize = IMAGE_SIZE)
plt.imshow(image, cmap = ‘gray’)
plt.title(‘Table without Lines’)#, plt.xticks([ ]), plt.yticks([ ])
plt.show( )

The training data set, generated at 632C, is used to train a cGAN, at 632D, thereby producing a trained cGAN 634B. During line prediction in tables 634, a test table without lines or with partial lines, 634A, is provided to the trained cGAN model 634B, which generates predicted lines for the test table. The predicted lines are superimposed (e.g., within the same step) onto the test table to produce a version of the test table with superimposed predicted lines 636.

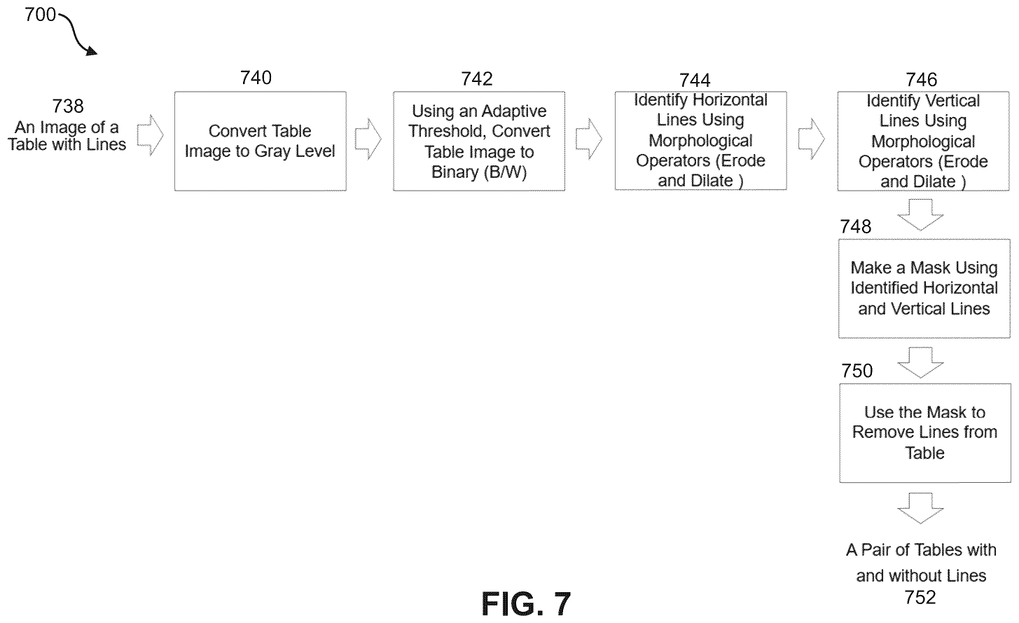

FIG. 7 is a flowchart illustrating an example method for removing lines from a table, according to some embodiments. As shown in FIG. 7, the method 700 begins upon receipt of an input image file that includes a lined table 738. During the method 700, the lined table is converted to grayscale (or “gray level”) at 740, and then converted, at 742 and using an adaptive threshold, into a binary format (e.g., black and white). Based on the binary format data, and using erosion and dilation morphological operators, horizontal lines are detected/identified at 744 and vertical lines are detected/identified at 746. A mask is generated, at 748, using the identified horizontal lines and vertical lines, and the mask is used, at 750, to remove lines from the table, thereby producing a lineless table. Upon completion of the method 700, a pair of tables 752 is output, the pair of tables 752 including the lined table and the lineless table.

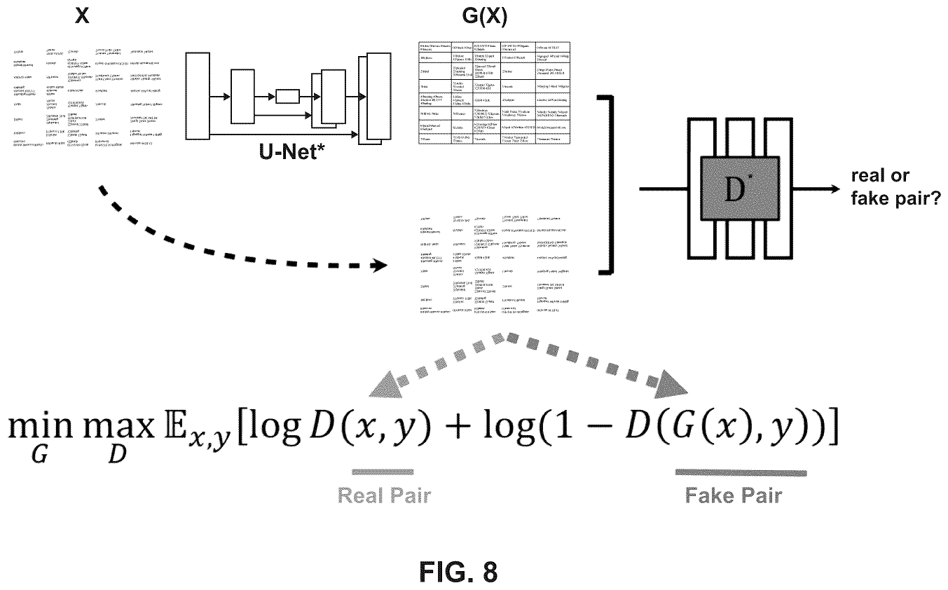

FIG. 8 is a diagram showing an architecture of a cGAN-based training system, according to some embodiments. As shown in FIG. 8, an initial lineless table X is converted into a lined table G(X) using a generative network encoder/decoder (U-Net). Both the lineless table X and the lined table G(X) (i.e., a table pair) are sent to a discriminative network (D) to determine whether the table pair is a real pair or a fake pair, for example according to the equation shown in FIG. 8 (in which y=ground truth and E_{x,y} is the joint expectation function). Both the U-Net and D are designed in multiresolution, for example using atrous convolution. Atrous convolution can provide a larger field of view (or “receptive field”) by providing holes in the kernel, thereby enlarging the size of the kernel without increasing the computational cost. By inserting an increasing number of holes into the kernel, the field of view can be expanded, facilitating a larger-scale view (e.g., including more global structures). Atrous convolution thus facilitates multiresolution analysis, accounting for both global and local structure/visual context of tables.

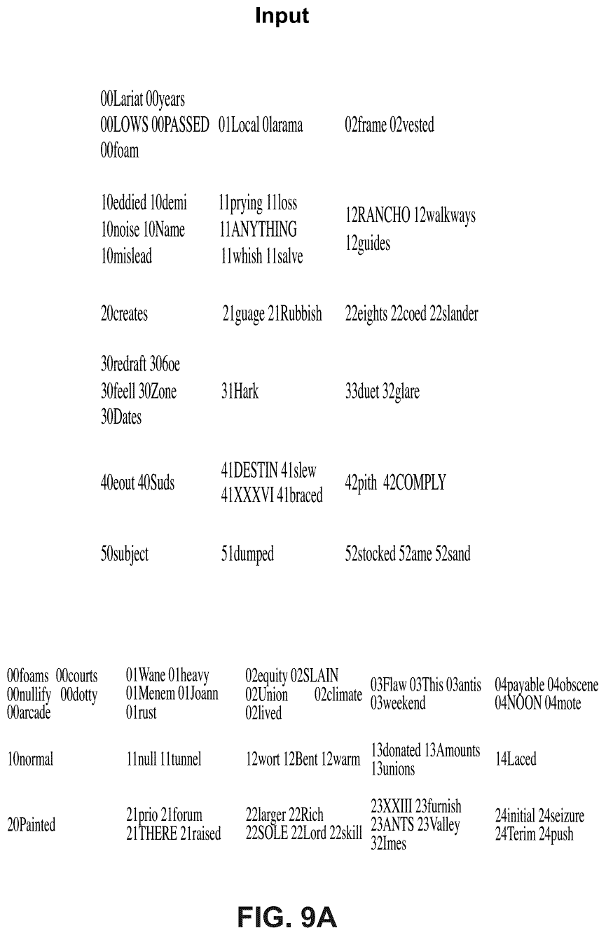

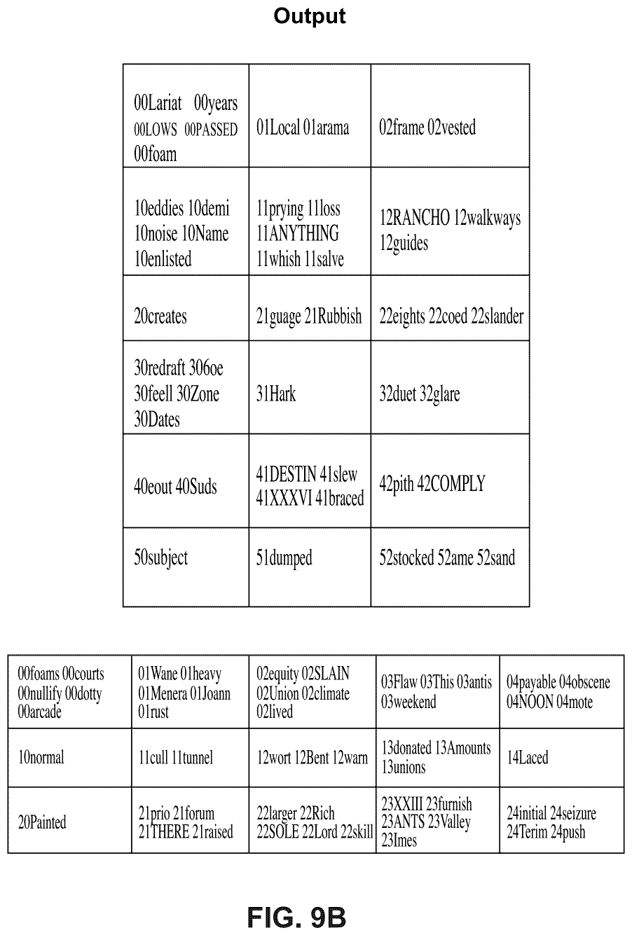

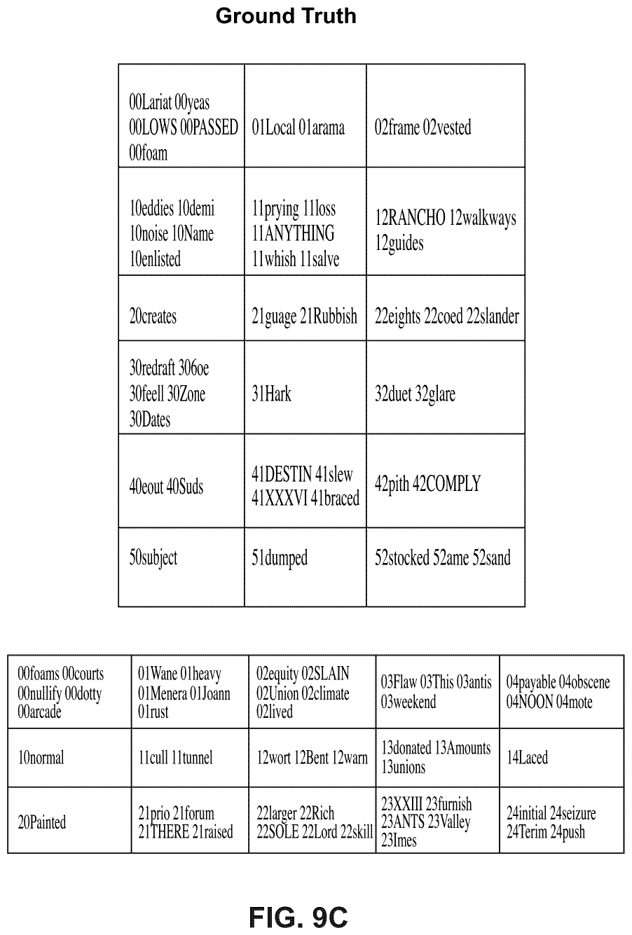

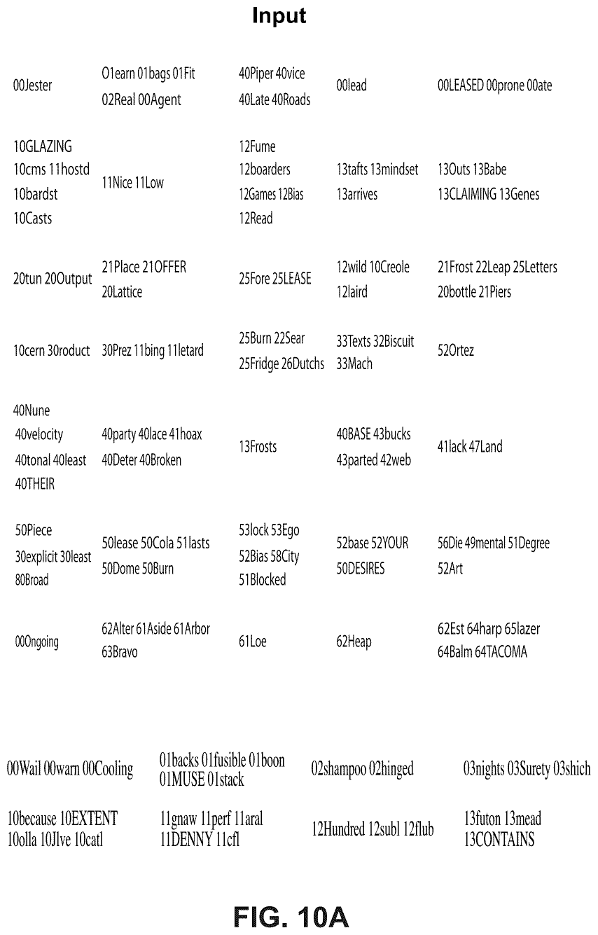

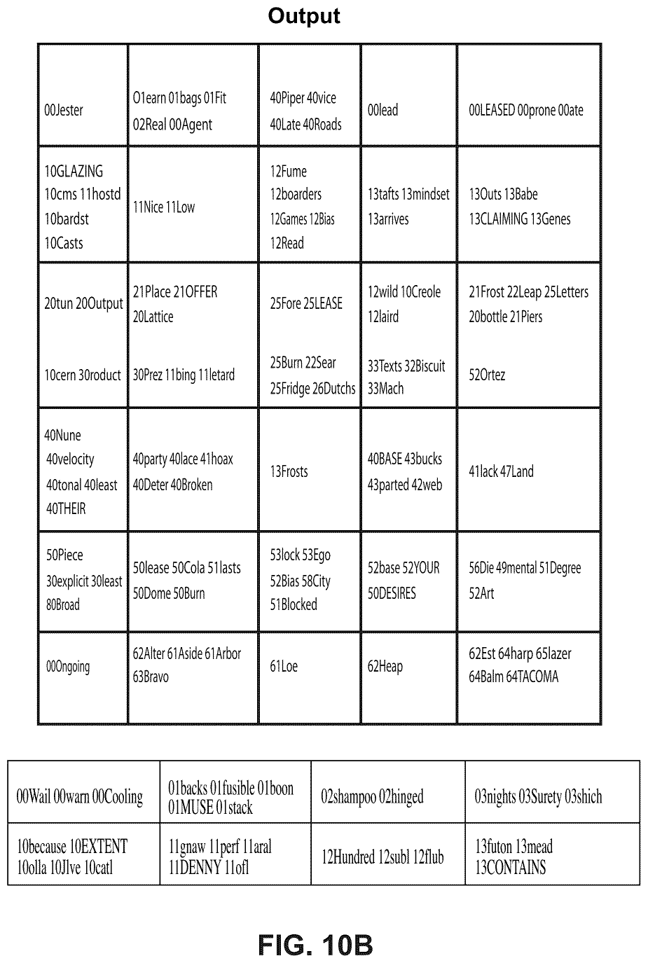

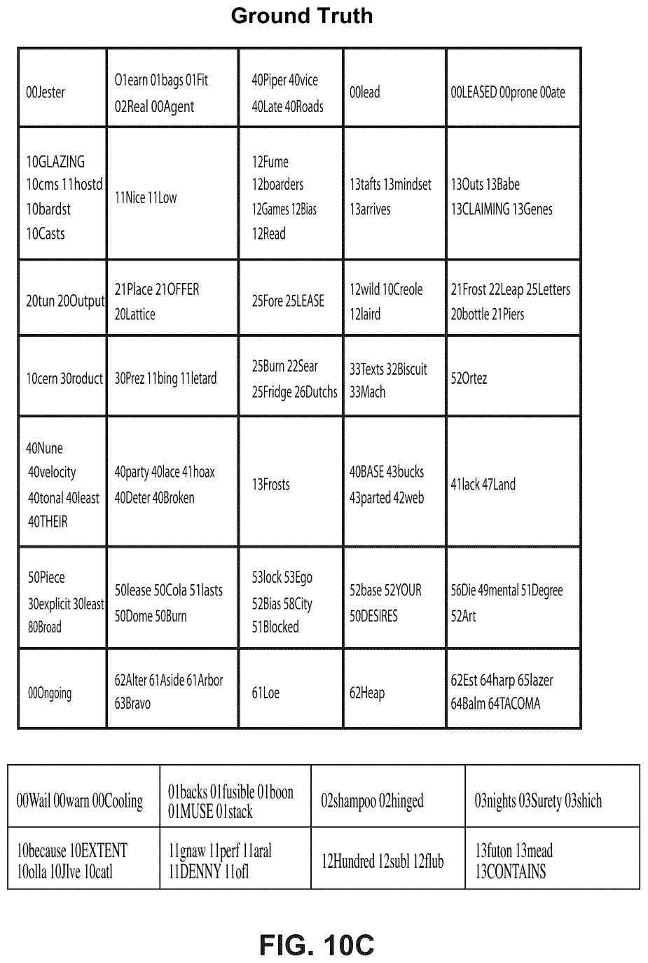

FIGS. 9A-9C are diagrams showing a first example set of results from converting a lineless table into a lined table, according to some embodiments. The leftmost column, labelled “Input,” shows an input lineless table. The center column, labelled “Output,” shows a lined table produced by overlaying/superimposing predicted lines (generated using a trained cGAN, for example, as described above in connection with FIGS. 2 and 6) onto the input lineless table. The rightmost column, labelled “Ground Truth,” shows the intended table structure (i.e., the proper/intended placement of lines for the input lineless table). FIGS. 10A-10C are diagrams showing a second example set of results from converting a lineless table into a lined table, organized in a manner similar to that of FIGS. 9A-9C, according to some embodiments.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. They are presented to assist in understanding and teach the embodiments.

The embodiments set forth herein are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the scope of the disclosure.

What is claimed is:

1. A non-transitory, processor-readable medium comprising code that when executed cause a processor to:
remove, using a mask, at least some lines from a first set of tables to generate a second set of tables;
train a conditional generative adversarial network (cGAN), using the first set of tables and the second set of tables, to produce a trained cGAN;
identify, using the trained cGAN, a plurality of lines for overlaying onto a lineless table; and
overlay the plurality of lines onto the lineless table to produce a lined table.

2. The processor-readable medium of claim 1, wherein the first set of tables includes a plurality of table images.

3. The processor-readable medium of claim 1, wherein the first set of tables includes a plurality of table images, the method further comprising:
convert the plurality of table images into a binary format based on an adaptive threshold.

4. The processor-readable medium of claim 1, wherein the cGAN is a supervised GAN.

5. The processor-readable medium of claim 1, wherein the cGAN includes a generative algorithm and a discriminative algorithm, the discriminative algorithm is configured to authenticate table pairs from the first set of tables and the second set of tables based on a predicted table produced by the generative algorithm.

6. The processor-readable medium of claim 1, wherein the first set of tables and the second set of tables collectively includes tables with lines and tables without lines.

7. The processor-readable medium of claim 1, wherein:
each table in the first set of table includes lines, and
each table in the second set of tables does not include lines.

8. The processor-readable medium of claim 1, wherein:
the cGAN includes a generative algorithm and a discriminative algorithm, the discriminative algorithm is configured to authenticate table pairs from the first set of tables and the second set of tables based on a predicted table produced by the generative algorithm, and
each of the generative algorithm and the discriminative algorithm includes at least one convolutional neural network layer.

9. A non-transitory, processor-readable medium comprising code that when executed cause a processor to:
generate training data, via a processor, the training data including:
a first dataset including at least one of lineless formatted data or partially lined formatted data, and
a second dataset including formatted data with format lines, at least some of the format lines from the second dataset removed using a mask to generate the first dataset; and
train an artificial neural network (ANN) using the training data based on a local visual structure of the training data and a global visual structure of the training data, to produce a trained ANN configured to predict line placement for at least one of a lineless table or a partially lined table.

10. The processor-readable medium of claim 9, wherein the ANN is a conditional generative adversarial network (cGAN).

11. The processor-readable medium of claim 9, further comprising code that when executed cause the processor to:
calculate a quality metric via a discriminative algorithm included in the ANN,
the code to train including code to train the ANN based on the quality metric.

12. The processor-readable medium of claim 9, wherein:
the ANN is a conditional generative adversarial network (cGAN), and
the cGAN is a supervised GAN.

13. The processor-readable medium of claim 9, wherein the training the ANN includes generating the predicted table based on the first dataset and the second dataset.

14. A processor-implemented method, comprising:
receiving a first table that is one of a lineless table or a partially lined table; and
generating a second table that is a lined table based on the first table and using a trained neural network model that predicts line placement based on structural attributes of the first table, the trained neural network trained using tables with lines and tables without lines, at least some lines from the tables with lines removed using a mask to generate the tables without lines.

15. The processor-implemented method of claim 14, wherein the trained neural network model is a cGAN.

16. The processor-implemented method of claim 14, wherein the generating the second table includes determining at least one predicted line and superimposing the predicted line onto an image of the first table.

17. The processor-implemented method of claim 14, further comprising:
sending a signal to cause display of the second table within a graphical user interface (GUI).

18. The processor-implemented method of claim 14, wherein:
the trained neural network model is a cGAN; and
the structural attributes of the first table include global visual structural attributes of the first table and local visual structural attributes of the first table.

19. The processor-implemented method of claim 14, wherein:
the trained neural network model is a cGAN that includes at least one convolutional neural network layer.

20. The processor-implemented method of claim 14, wherein:
the trained neural network model is a cGAN that includes at least one convolutional neural network layer,
the at least one convolutional neural network layer includes an atrous convolutional neural network layer, and
the structural attributes of the first table include at least one of global visual structural attributes of the first table or local visual structural attributes of the first table.
